(19) United States
(12) Patent Application Publication
(10) Pub. No.: US 2024/0028868 A1
(43) Pub. Date: Jan. 25, 2024

(54) SYSTEM FOR LOGIC RULE INDUCTION ON KNOWLEDGE GRAPHS OF ENGINEERING SYSTEMS

(71) Applicant: Siemens Aktiengesellschaft, Munich (DE)

(72) Inventors: Arun Ramamurthy, Plainsboro, NJ (US); Yuyu Zhang, Atlanta, GA (US); Sanjeev Srivastava, Chantilly, VA (US); Livio Dalloro, Plainsboro, NJ (US)

(73) Assignee: Siemens Aktiengesellschaft, Munich (DE)

(21) Appl. No.: 18/042,303

(22) PCT Filed: Aug. 31, 2020
(86) PCT No.: PCT/US2020/048670

§ 371 Date: Feb. 21, 2023

(51) Int. Cl. G06N 3/042

(52) U.S. Cl. CPC G06N 3/042

(57) ABSTRACT

System and method for logic rule formula induction on knowledge graphs for engineering system designs include receiving plurality of knowledge graphs for an engineering system. For a disconnected knowledge graph, agglomerative beam search is constrained to edges connected from node of interest, and candidate formulas are generated representing a respective edge found by the beam search engine, each formula constrained by a requirement of at least two arguments for defined formula chain length. Formula evaluation establishes whether each candidate formula is valid. Top ranked formulas are selected from the candidate formulas according to defined criteria. For well-connected graphs, a graph neural network is trained to predict first class for a query graph and second class for distractor graph. Counterfactual solver engine solves for minimum number of edits to query graph toward distractor graph which transforms predicted first class of the query graph to predicted second class.

### TECHNICAL FIELD

This application relates to machine learning applied to engineering systems. More particularly, this application relates to logic rule induction from knowledge graph analysis in an engineering design domain.

### BACKGROUND

The problem of learning first-order logic rules from data has been a long-standing challenge in machine learning and plays an important role in many applications. For example, for systems like gas turbines, electrical grid, or smart buildings, an enormous amount of data is recorded by sensors. For such systems, one can construct a knowledge graph to represent the domain knowledge of the system. In an engineering design process, machine learning can be applied to accelerate the search for an optimum design among a multitude of candidate designs. Where a design consists of many interconnected parts, each part having several alternatives to select from, the permutations of available configurations can be staggering.

Logic rules are human interpretable representations for knowledge based reasoning, which can provide better insight to understand the property of data, compared to black-box supervised learning model. In many cases, this interpretability leads to robustness in transfer learning. Also, logic rules are very helpful for many downstream tasks (target tasks), such as question answering, knowledge distillation from human experience, and knowledge extraction from open-domain text. It is challenging to extract rules from knowledge graphs due to the combinatorial search space. It is computationally intractable to perform brute-force search of all possible rules. The number of candidate logic rule formulas can easily go to billions or even trillions for practical applications.

Existing methods use templates of first-order logic formulas with various constraints to reduce the search space. Traditional inductive logic programming methods are not only inefficient, but also unable to handle noise in the real-world data. Recent methods using deep learning techniques (e.g., Neural Logic Programming) can handle noise in data, but require that the logic variables in the formula are chained, and each predicate must have exactly two arguments. Even with these restrictions, existing methods can only extract logic formulas with up to two or three predicates, which is grossly inadequate for the modeling requirements of many industrial applications.

### SUMMARY

A system provides logic rule induction on knowledge graphs of engineering systems by a first framework for searching disconnected knowledge graphs and a second framework for searching well connected knowledge graphs. In the first framework, top ranked candidates of first-order logic rule formulas are generated to reduce the search space of knowledge graphs as a formula building process searches for longer formulas. The second framework applies a graph neural network (GNN) with a counterfactual solver engine to capture local topology patterns of knowledge graphs and to abstract first-order logic rule formulas based on atomic actions to the graphs. The induced first-order logic rules explain an optimum design for the engineering system.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of a system for first-order logic formula induction on knowledge graphs in accordance with embodiments of this disclosure.

FIG. 2 shows an example of a framework first-order logic formula induction from disconnected knowledge graphs in accordance with embodiments of this disclosure.

FIG. 3 shows an example of an agglomerative beam search sequence according to embodiments of this disclosure.

FIG. 4 shows an example of a formula expansion from candidate formulas according to embodiments of this disclosure.

FIG. 5 shows an example of a counterfactual formulation for a training a graphic neural network used for extracting logic rule formulas from well-connected knowledge graphs in accordance with embodiments of this disclosure.

FIG. 6 shows an example of atomic actions on a well-connected knowledge to generate counterfactuals for logic rule induction in accordance with embodiments of this disclosure

FIG. 7 illustrates an example of a computing environment within which embodiments of the disclosure may be implemented.

### DETAILED DESCRIPTION

Methods and systems are disclosed for significant improvement in the efficiency of searching first-order logic formulas on knowledge graphs. For disconnected knowledge graphs, an agglomerative beam search method with dynamic formula generation and reverse index techniques is used. For large-scale well-connected knowledge graphs, graph neural networks are incorporated to avoid the intractable combinatorial search space. A technical problem solved by the embodiments of this disclosure includes the need to define first-order logic formulas for an optimum target design extracted from among a multitude of candidate designs, where the search space can be managed to reduce the processing time and effort for improved efficiency. In an aspect, the derived logic formulas can be configured as explanation for the optimum design, where a successful design is judged both by performance of elements individually and by relationships of interconnected elements that perform to optimum standards. Unlike conventional approaches relying on formula templates to reduce the search space, the disclosed frameworks can learn formulas from zero (without templates) and yet quickly derive the logic formulas. While conventional approaches constrain formulas to two or three predicates or chain length of two to three elements, the disclosed frameworks have no such constraints.

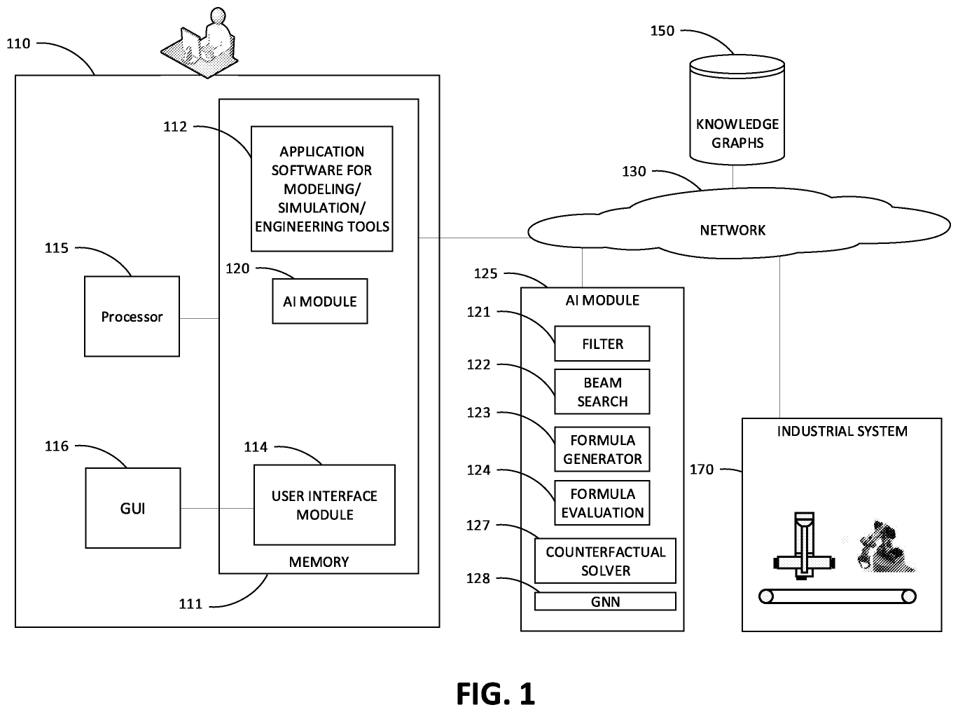

FIG. 1 shows an example of a system for first-order logic formula induction on knowledge graphs in accordance with embodiments of this disclosure. In an embodiment, a design engineering project is performed for an industrial system 170, such as an automation system, having machines and sensors that can provide feedback. A computing device 110 includes a processor 115 and memory 111 (e.g., a non-transitory computer readable media) on which is stored various computer applications, modules or executable programs. Engineering applications 112 may include software for one or more of modeling tools, a simulation engine, computer aided design (CAD) tools, and other engineering tools accessible to a user via a graphical user interface (GUI) 116 and a user interface module 114 that drives the display feed for GUI 116 and processes user inputs back to the processor 115, all of which are useful for performing system design, such as in the form of 2D or 3D renderings. A network 130, such as a local area network (LAN), wide area network (WAN), or an internet based network, connects computing device 110 to a repository of knowledge graphs 150.

In an embodiment, engineering data generated by engineering applications 112 is monitored and organized into knowledge graphs 150 as semantic data. Knowledge graphs 150 are the accumulation of design data exported from engineering applications 112 and generated by knowledge graph algorithm that processes an ontology of the exported data. In some embodiments, knowledge graphs are obtained from a supplier, such as a vendor or manufacturer of similar systems, subsystems, or components related to the system under design. The ontology governs what types of elements of a system and the relationships between the elements are present (e.g., motor control, logic function block, associated sensor signals). The ontology also describes properties of the elements and the element relationships, and may organize the element types into hierarchies, such as super-types and sub-types. A knowledge graph 150 represents the ontology as nodes and edges that correspond to a set of elements of the ontology and element relationships, respectively. For example, engineering system information contained in the ontology may include design parameters, sensor signal information, operation range parameters (e.g., voltage, current, temperature, stresses, etc.). As measured data is obtained from sensors in the industrial system 170, it can be added to the various nodes and edges in a knowledge graph 150. Hence, the knowledge graph structure may contain structured and static domain knowledge about the system. The measured data will contain both implicit and explicit knowledge about the system that can be very valuable for improving a system's operational performance or future designs for such a system. Explicit knowledge may include, for example, trends, correlation patterns, data values going outside of required limits, etc. Implicit knowledge may include rules driving the system performance in some specific way, constraints and dependency among certain set of variables, non-linear relationship among variables, etc.

AI module 125 is configured to perform first-order logic formula induction on knowledge graphs 150 using a plurality of modules including a filter 121, a beam search engine 122, a dynamic formula generator 123, a formula evaluation engine 124, a counterfactual solver engine 127, and a graph neural network module 128. AI module 125 analyzes one or more knowledge graphs to induce first-order logic rules that express the optimum design. In an embodiment, induction of first-order logic rule formulas involves deriving a formula that is a chain of terms that represent component relationships of a system design. Using an automobile design as an example, various knowledge graphs may be available to be analyzed, each graph representation being associated with a different set of component selections and combinations for different designs of the automobile. For example, five known designs have five knowledge graphs to analyze for making a new sixth design. The first-order logic formula to be derived consists of a chain of terms that may relate to engineering system components, such as for instance, an engine, chassis, axel, and wheel extracted from the knowledge graph for the mechanical interconnection domain. Another formula chain may represent the electrical domain, such as elements representing an interconnected computer network for various sensors associated with the engine, chassis, axel and wheel. A simplistic formula chain example is a chain of four terms, where A [is related to] B, B [is related to] C and D, C [is related to] B and D, where “is related to” can take the form of any relational syntax depending on the particular relationship (e.g., is connected to, is a component of, is a sensor for, etc.). According to the embodiments, a constraint for chain length may be fitting the formula within the available memory of the computer with no other constraint.

Briefly, the filter 121 is used to determine knowledge graphs that are disconnected for performing formula induction according to a first process of this disclosure. For example, the filter 121 may detect distinct clusters in a knowledge graph and allow such a knowledge graph to pass through as a disconnected knowledge graph. Disconnected knowledge graphs are explored by the beam search engine 122, which performs step-wise exploration of a knowledge graph in increments of one beam, i.e., a knowledge graph edge. Herein, the terms “beams” and “edges” are used interchangeably. The beam search begins at a node having a top ranked formula, and at each cycle of an iterative process, extends the search to all connected nodes, hence performing a single beam increment search. The dynamic formula generator 123 defines a first-order logic formula for each searched beam, such as P(t1, . . . , tn), where n-ary predicate P has at least two arguments (i.e., n>=2), such as terms t1 and t2. To evaluate the generated formulas, the formula evaluation engine 124 maps the formulas according to edge type, forming sets of subgraphs and finds set intersections to determine which subgraphs satisfy the candidate formula being evaluated. This serves to significantly accelerate the formula evaluation as grounding of every candidate formula is avoided.

Disconnected Knowledge Graph Analysis

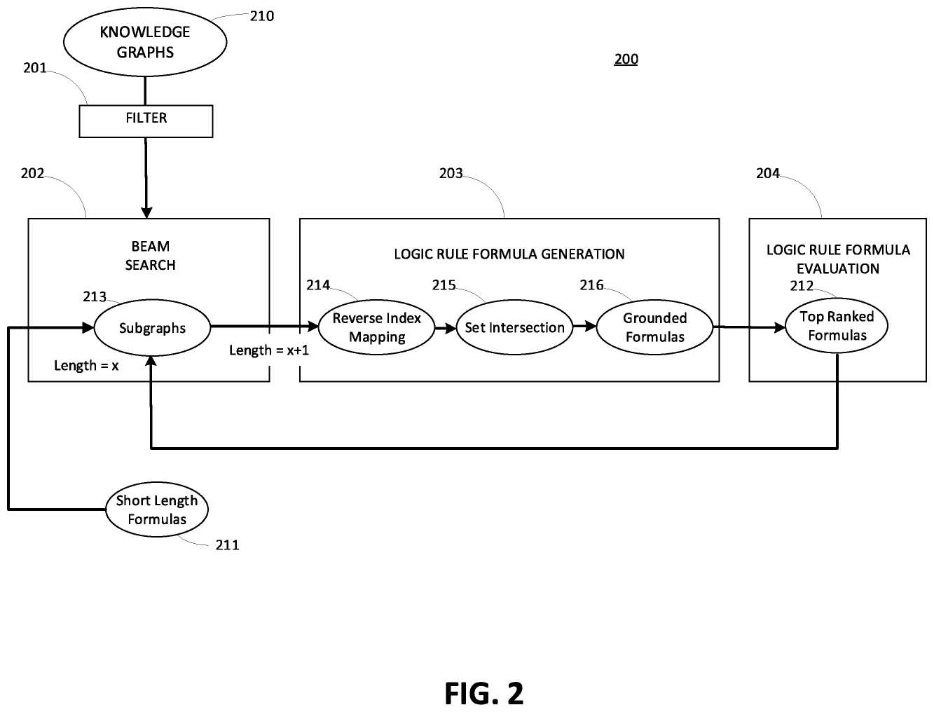

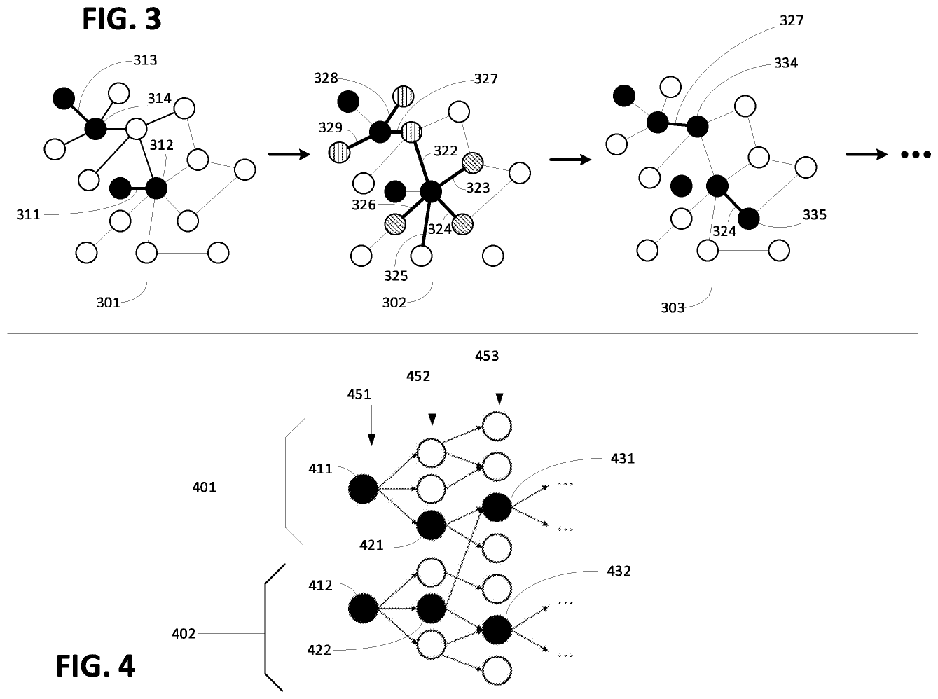

FIG. 2 shows an example of a framework for first-order logic formula induction from disconnected knowledge graphs in accordance with embodiments of this disclosure. For knowledge graphs determined to be categorically disconnected by filter 121, framework 200 builds a set of first-order logic rule formulas through an iterative process of knowledge graph data extractions that produces a set of top ranked candidate logic rule formulas. In an aspect, a single iteration for framework 200 consists of beam search 202, logic rule formula generation 203 and logic rule formula evaluation 204. Beginning with a set of knowledge graphs 210, filter 201 detects a first disconnected knowledge graph, and for the initial cycle of framework 200, beam search engine 122 receives k known short length logic rule formulas 211 as input. The beam search 202 process begins at beams in the disconnected knowledge graph that correspond to the k short length logic rule formulas. The beam search 202 proceeds as described below with respect to FIG. 3.

FIG. 3 shows an example of an agglomerative beam search sequence according to embodiments of this disclosure. In an embodiment, beam search engine 122 performs an agglomerative beam search 202 such that the search domain expands one hop at a time (i.e., one edge of a knowledge graph for a given iteration of framework 200) to search for longer logic rule formulas. As shown in FIG. 3, the beam search sequence begins at step 301 in which the initial k logic rule formulas 211 correspond with initial beams 311, 313 in the knowledge graph. In subsequent cycles, k top ranked logic rule formulas 212 feed the beam search 202. While embodiments of this disclosure are capable of searching and evaluating candidate formulas for k>>1000, for this simplistic example, k=2. In an embodiment, beam search 202 applies identifies a search domain that is one beam hop from initial beams 311, 313. Hence, the search domain includes all beams that are connected to nodes of interest 312, 314, being inner nodes of beams 311, 313. The beam search 202 defines subgraphs for each path that tracks the expanded set of searched beams. A graphical representation of this tracking is illustrated in FIG. 3 in step 302 of the sequence where subgraphs are formed by expanding beams from nodes of interest 312, 314. For this first beam search, beams 322, 323, 324, 325, 326 are identified as candidates for expanding the logic rule formula associated with beam 311 in the logic rule induction, while beams 327, 328, 329 are identified as candidates for formula expansion from beam 313. Formula generation 203 and evaluation 204, described below in greater detail, are performed for the current cycle of framework 200 using knowledge graph objects of each subgraph defined in step 302. The output of the evaluation 204 for the current cycle is top k logic rule formulas 212, which then triggers the next beam search 303. In this example, beams 324 and 327 correspond to the top k formulas (for k=2), so the nodes of interest at step 303 are nodes 334, 335. From all candidate beams of step 302, only beams 324 and 327 remain at step 303 for the logic rule induction of the second cycle. In a similar manner as described for step 302, the beam search domain will expand from the subgraphs shown in step 303 by a single beam hop from each of nodes 334 and 335. Beam search 202 is repeated in a similar manner for subsequent cycles until the expanded subgraphs exhaust k top ranked formulas, or until the desired length of logic rule formula is achieved. Other limits or constraints may also limit the number of cycles. As can be seen in FIG. 3, by constraining iterative beam searches to top k candidates as the source for formula expansion, the number of candidate formulas to be generated and evaluated is substantially reduced. On a practical scale, even where k>>1000, the computation savings are significant when a knowledge graph may have as many as billions or trillions of edges.

FIG. 4 shows an example of constrained formula expansion from candidate formulas according to embodiments of this disclosure. In an embodiment, the beam search algorithm keeps track of top k ranked formulas according to the specified evaluation metrics, where k is a constant that specifies how many formulas are needed as the goal. In practice, setting k on a scale of thousands can be easily handled by the beam search algorithm 202. As a result, the exponentially increasing search space for longer formula size is avoided. As a simplistic example for the purpose of illustration, the formula expansion in FIG. 4 is performed for k=2. Beginning with two formula trees 401, 402, where the elements correspond to candidate formulas from the beams shown in FIG. 3, there are two top ranked formulas represented by elements 411 and 412. In a next cycle of the framework 200, two top ranked formulas are determined from among the connected beams in the beam search, shown as elements 421 and 422 at the tree level 452. The next top ranked formulas are represented by elements 431, 432 at tree level 453, determined in the third cycle. In this way, formula evaluation is prevented from expanding exponentially with each iteration of framework 200.

Returning to FIG. 2, next will be described the dynamic logic rule formula generation 203 performed for each subgraph defined by beam search 202. While the beam search 202 is configured to reduce computations, generating a candidate formula for all subgraphs 213 would be computationally expensive, since each candidate formula must be checked for whether its condition is satisfied, even with a shortcut break for any predicate that does not satisfy the subgraph structure. In an embodiment, further reduction in computations for logic rule formula generation and evaluation 204 is achieved through generation of a reverse index mapping 214 and a set intersection 215 as part of logic rule formula generation 203. A reverse index is generated by formula generator 123 for mapping each type of edge (beam) associated with a candidate formula to a set of subgraphs in which it appears. In a set intersection operation, a logical AND operator is applied to the sets of subgraphs of reverse index mapping 214 to find a number of subgraphs that satisfy the candidate formula currently being generated. In this way, duplicate subgraphs are eliminated from consideration for formula generation, the full grounding of every candidate formula is avoided, and the formula evaluation phase 204 is significantly accelerated by having less candidate formulas to evaluate.

Compared to a baseline method without reverse index, the number of candidate logic rule formulas generated is significantly reduced. As an example, for logic rule formulas of length 2, 3, and 4, which have 2, 3, and 4 predicates respectively, the number of generated candidate rules are reduced by 7×, 22×, and 48×, respectively. For longer formulas, the baseline method is computationally prohibitive to generate all candidate rules, while the improved formula generation process 203 can easily generate candidate rules from the subset of subgraphs derived by the agglomerative beam search 202 as described.

Logic rule formula generation 203 generates first-order logic rule formulas that are formulated according to logic rule syntax associated with subgraph connections. Because framework 200 bases formulas on beam searching connected beams, each subgraph is inherently connected. This constraint corresponds with the focus of the framework 200 being on entity cliques instead of disconnected subgraphs in practical applications.

Grounded formulas 216 are derived from substituting constants for logic rule formula variables. The formula grounding is dynamic in that not all candidate formulas are grounded, but rather a subset is grounded as a result of the reverse index and set intersection operations. As an example of deriving grounded formulas, consider a knowledge graph 210 that relates to an engineering systems design for a vehicle having 15 available engine types, 11 chassis types, and 25 transaxle types, the subgraph for a particular knowledge graph is grounded by the following instances: engine 12 of 15 is connected chassis 5 of 11, which is connected to transaxle 23 of 25. For a practical example, dynamic grounding of many (˜100) subgraphs of numerous knowledge graphs can be deterministic of specific probabilities for formulas. For example, if engine 12 is rarely connected to chassis 2, then there is strong certainty that the likelihood for such a connection is low.

Logic rule formula evaluation 204 ranks the grounded formulas 216. To rank the candidate formulas, criteria are selected, such as coverage, accuracy, confidence score, or a combination thereof. A particular number k of the top ranked formulas is kept for future search of longer formulas.

As another advantage of the reverse index mapping 214 and set intersection 215, the formula evaluation 204 is significantly more efficient than a baseline approach. Test results of the framework 200 against a baseline method yielded significant time savings. For candidate formulas with 2, 3, and 4 predicates, the framework 200 method can achieve faster formula evaluation processing time by factors of 22×, 660×, and 851× compared to the baseline method. For longer formulas, the baseline methods are too slow to evaluate, while the framework 100 method can complete the candidate formula generation very efficiently. For example, formulas with 12 predicates can be evaluated in around 30 minutes.

Once the top k ranked formulas are derived by the formula evaluation 204, the process repeats, beginning with another beam search 202 for subgraphs of a chain length x+1. The framework 200 performs an iterative process until subgraph lengths have reached a predefined maximum limit or the limit of the knowledge graph, or until no new candidate formulas of length x+1 searched in the knowledge graph satisfy the formula criteria. The limit for k top formulas may be predefined as a constraint based on a tradeoff between robustness and computation time and memory.

Well-Connected Knowledge Graph Analysis

Having covered a framework for induction of logic rule formulas from disconnected knowledge graphs as described above, next is described an approach for logic rule formula induction for large-scale well-connected knowledge graphs. In an embodiment, filter 121 determines that a received knowledge graph 150 satisfies a connectedness criteria and triggers a logic rule induction on the knowledge graph as a well-connected knowledge graph according to the following description. Counterfactual solver 127 works together with GNN 128 to overcome the issues with rapid scaling when grounding logic formulas. Counterfactuals is an approach at the intersection of computational cognitive science and statistics that attempts to predict the outcome of a certain event given that the event was not observed by the model. To illustrate how counterfactuals are applied to well-connected knowledge graphs, recall the AI concept of explanation of a logic rule by which the rule explains why a classification is as stated. As an alternative approach, the counterfactual solver engine 127 finds one or more elements common to both a query knowledge graph and a distractor knowledge graph such that if the element was changed, the query knowledge graph would be classified as being more likely to be the distractor knowledge graph (or a “counterpart” version or alternate version of the query graph). The benefit of applying a counterfactual analysis is that it can provide an understanding of which elements of a knowledge graph are essential or critical to keeping its classification intact. That is, by identifying the minimal atomic change to a knowledge graph that triggers a different classification, a discriminative validation of the logic rule is established. In short, what situation makes a knowledge graph classification X instead of Y.

More formally, given a certain classification for a subgraph or a node of the knowledge graph, the problem of explanation is formulated as being the minimum amount of change that needs to be created to the knowledge graph that results in a misclassification of the subgraph or the node using a combined operation of GNN 128 and counterfactual solver engine 127. An optimization problem can be formulated in an attempt to identify the minimum number of edits to the knowledge graph that results in a misclassification of the node. This translates directly to the formulation of counterfactuals as the identification of a graph structure that is similar to the one being classified but is sufficiently different to results in a misclassification. The resultant graph structure is the generated counterfactual.

Given a query knowledge graph G for which the GNN 128 predicts class c, an objective is to produce a counterfactual explanation that finds minimum changes to graph G, looking to changes towards a distractor graph G′ which the GNN previously predicted as class c′. The solution is to perform a transformation from G to counterfactual G* such that G* appears to be an instance of class c′ to a trained GNN model g. Here, the GNN can be represented as g_{c}(f(G)) to denote a log-probability of class c for graph G. Mathematically, transformation from G to G* can be expressed as follows:

f(G*)=(1−α)∘f(G)+α∘Pf(G′) Eq. (1)

where: 1 is vector of all ones;
α is a binary gating vector; and
∘ is a Hadamard product between a vector and a matrix.

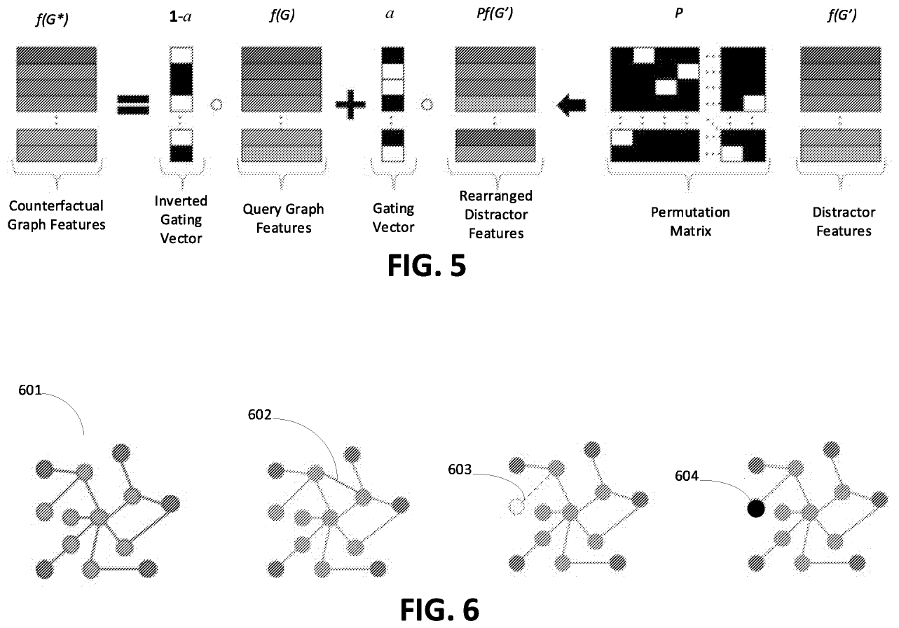

FIG. 5 shows an example of applying counterfactual with a GNN to induce logic rule formulas from large scale well-connected knowledge graphs in accordance with embodiments of this disclosure. In an embodiment, counterfactual solver 127 solves an optimization by minimizing the norm of binary gating vector a, which represents the minimum number of edits from graph G′ to query graph G to generate counterfactual graph G*. This can be expressed as follows:

$${min}_{P , a} {‖ a ‖}_{1} \qquad Eq . ( 2 )$$

$$s . t . , {c}^{′} = arg max g ( ( 1 - a ) ∘ f ( G ) + a ∘ Pf ( {G}^{′} ) )$$

$${a}_{i} ϵ \{ 0 , 1 \} ∀ i and P ϵ 𝒫$$

where:
f(G) is a query graph feature vector
f(G*) is a counterfactual graph feature vector
f(G′) is a distractor graph feature vector
P is a permutation matrix that rearranges elements of f(G′) to align with elements of f(G),
Pf(G′) is rearranged distractor feature vector
P is a set of all permutation matrices

In an embodiment, the GNN is trained to learn the permutation matrix P, which enables determination of the minimum number of edits directly from the knowledge graph. This approach results in a faster processing algorithm that enables the training of the system in an end-to-end fashion. The result of this approach is the generation of a GNN that can interpret the learned parameters to discover human readable logic formulas on the large-scale knowledge graph. Since the GNN can capture local topology patterns in the graph, the knowledge embedded in the learned model can be abstracted and generalized to logic formulas.

FIG. 6 shows examples of atomic actions on a well-connected knowledge graph to generate counterfactuals for reducing search space logic rule induction in accordance with embodiments of this disclosure. In this example, a very simplistic graph is shown for illustrative purposes, as actual knowledge graphs may comprise millions or billions of nodes. As shown, starting with a query graph 601, various atomic edits include a formula addition edit 602, a formula subtraction edit 603, and a term edit 604 as shown in FIG. 6. In each case a single “atomic” edit is made to the graph 601 to analyze whether the graph class has changed when analyzed by counterfactual solver engine 127.

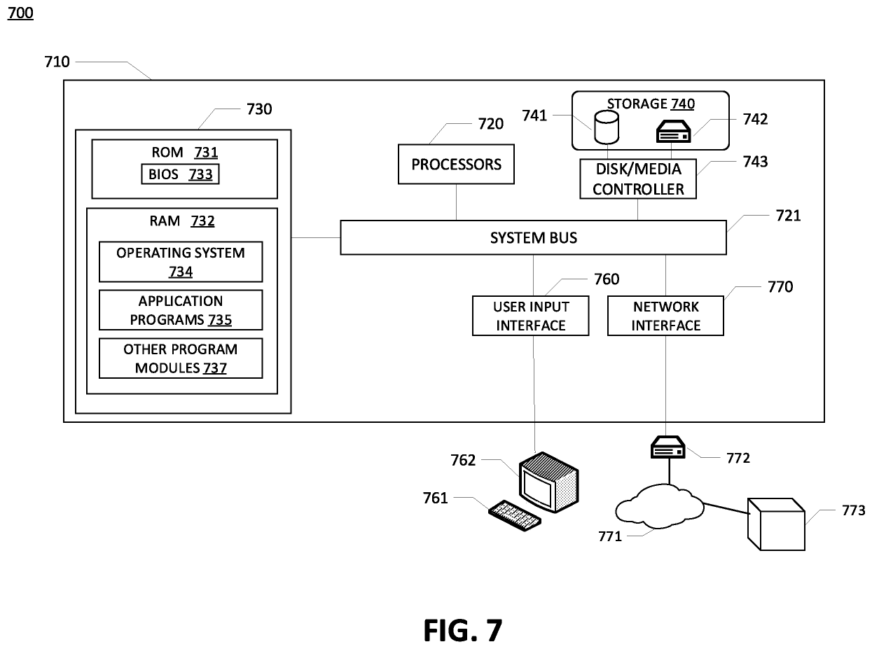

FIG. 7 illustrates an example of a computing environment within which embodiments of the present disclosure may be implemented. A computing environment 700 includes a computer system 710 that may include a communication mechanism such as a system bus 721 or other communication mechanism for communicating information within the computer system 710. The computer system 710 further includes one or more processors 720 coupled with the system bus 721 for processing the information. In an embodiment, computing environment 700 corresponds to system for logic rule induction on knowledge graphs, in which the computer system 710 relates to a computer described below in greater detail.

The processors 720 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 720 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 721 may include at least one of a system bus, a memory bus, an address bus, or a message bus, and may permit exchange of information (e.g., data (including computer-executable code), signaling, etc.) between various components of the computer system 710. The system bus 721 may include, without limitation, a memory bus or a memory controller, a peripheral bus, an accelerated graphics port, and so forth. The system bus 721 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 7, the computer system 710 may also include a system memory 730 coupled to the system bus 721 for storing information and instructions to be executed by processors 720. The system memory 730 may include computer readable storage media in the form of volatile and/or nonvolatile memory, such as read only memory (ROM) 731 and/or random access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application modules 735, and other program modules 736. Application modules 735 may include aforementioned modules described for FIG. 1 and may also include a user portal for development of the application program, allowing input parameters to be entered and modified as necessary.

The operating system 734 may be loaded into the memory 730 and may provide an interface between other application software executing on the computer system 710 and hardware resources of the computer system 710. More specifically, the operating system 734 may include a set of computer-executable instructions for managing hardware resources of the computer system 710 and for providing common services to other application programs (e.g., managing memory allocation among various application programs). In certain example embodiments, the operating system 734 may control execution of one or more of the program modules depicted as being stored in the data storage 740. The operating system 734 may include any operating system now known or which may be developed in the future including, but not limited to, any server operating system, any mainframe operating system, or any other proprietary or non-proprietary operating system.

The computer system 710 may also include a disk/media controller 743 coupled to the system bus 721 to control one or more storage devices for storing information and instructions, such as a magnetic hard disk 741 and/or a removable media drive 742 (e.g., floppy disk drive, compact disc drive, tape drive, flash drive, and/or solid state drive). Storage devices 740 may be added to the computer system 710 using an appropriate device interface (e.g., a small computer system interface (SCSI), integrated device electronics (IDE), Universal Serial Bus (USB), or FireWire). Storage devices 741, 742 may be external to the computer system 710.

The computer system 710 may include a user input/output interface 760 for communication with one or more input devices 761, such as a keyboard, touchscreen, tablet and/or a pointing device, and output devices 762, such as a display device, to enable interacting with a computer user and providing information to the processors 720.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium of storage 740, such as the magnetic hard disk 741 or the removable media drive 742. The magnetic hard disk 741 and/or removable media drive 742 may contain one or more data stores and data files used by embodiments of the present disclosure. The data store 740 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 700 may further include the computer system 710 operating in a networked environment using logical connections to one or more remote computers, such as remote computing device 773. The network interface 770 may enable communication, for example, with other remote devices 773 or systems and/or the storage devices 741, 742 via the network 771. Remote computing device 773 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 773). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

It should be appreciated that the program modules, applications, computer-executable instructions, code, or the like depicted in FIG. 7 as being stored in the system memory 730 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 710, the remote device 773, and/or hosted on other computing device(s) accessible via one or more of the network(s) 771, may be provided to support functionality provided by the program modules, applications, or computer-executable code depicted in FIG. 7 and/or additional or alternate functionality. Further, functionality may be modularized differently such that processing described as being supported collectively by the collection of program modules depicted in FIG. 7 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 7 may be implemented, at least partially, in hardware and/or firmware across any number of devices.

It should further be appreciated that the computer system 710 may include alternate and/or additional hardware, software, or firmware components beyond those described or depicted without departing from the scope of the disclosure. More particularly, it should be appreciated that software, firmware, or hardware components depicted as forming part of the computer system 710 are merely illustrative and that some components may not be present or additional components may be provided in various embodiments. While various illustrative program modules have been depicted and described as software modules stored in system memory 730, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for first-order logic rule formula induction on knowledge graphs for engineering system designs, comprising:
a processor; and
a memory having stored thereon modules executed by the processor, the modules comprising:
an artificial intelligence (AI) module configured to receive a plurality of knowledge graphs for an engineering system, each knowledge graph representing a unique engineering system design serving as candidate, the AI module comprising:
a filtering module to determine whether each of the plurality of knowledge graphs are disconnected based on identifying significant portions of disconnected nodes notable by distinct clusters of nodes, and responsive to a determination that a knowledge graph is disconnected, triggering a first-order logic rule induction on the disconnected knowledge graph;
a beam search engine configured to perform, for each disconnected knowledge graph, an agglomerative search constrained to edges connected from a node of interest and to define a subgraph for each path of the search;
a formula generator configured to generate a plurality of candidate logic rule formulas, wherein for each candidate logic rule formula: (i) duplicate subgraphs are eliminated by using a reverse index to map edge types to a set of subgraphs and finding an intersection of subgraphs that satisfy a candidate formula, and (ii) the formula is constrained by a requirement of at least two arguments for a formula chain length L; and
a formula evaluator configured to perform formula evaluation on the grounded candidate formulas, and select top k ranked formulas from the candidate formulas according to evaluation criteria;
wherein the logic formula induction repeats iterations of the agglomerative search, candidate formula generation, and formula evaluation by extending the candidate formulas to chain length L+1 for each iteration, repeating until a defined limit for chain length is reached.

2. The system of claim 1, wherein the evaluation criteria include coverage, accuracy, confidence score, or a combination thereof.

3. The system of claim 1, wherein the agglomerative beam search expands the search domain one hop at each iteration.

4. The system of claim 1, wherein the formulas are dynamically grounded by labeling or enumerating each node as a specific instance from among all different possibilities of connections.

5. The system of claim 1, wherein the filtering module determines that a knowledge graph satisfies a connectedness criteria and triggering a logic rule formula induction as a connected knowledge graph, the system further comprising:
a graph neural network trained to predict a first class of a query graph and to predict a second class for a distractor graph; and
a counterfactual solver engine configured to solve for a minimum number of edits to the query graph toward the distractor graph which transforms the predicted first class of the query graph to the predicted second class.

6. The system of claim 5, wherein the counterfactual solver engine is further configured to:
rearrange features of the distractor graph according to a permutation matrix;
apply a first Hadamard product of the gating vector and a matrix of the rearranged features; and
apply a second Hadamard product of an inversion of the gating vector and a matrix of the query graph features;
wherein a counterfactual matrix is formed by the sum of the first and second Hadamard products, and the minimum number of edits is represented by the gating vector.

7. The system of claim 6, wherein the graph neural network is trained to learn the permutation matrix.

8. A method for first-order logic rule formula induction on knowledge graphs for engineering system designs, comprising:
receiving, by an artificial intelligence (AI) module, a plurality of knowledge graphs for an engineering system, wherein each knowledge graph has significant portions of disconnected nodes notable by distinct clusters of nodes, each knowledge graph representing a unique engineering system design serving as candidate;
determining whether each of the plurality of knowledge graphs are disconnected, and responsive to a determination that a knowledge graph is disconnected, triggering a first-order logic rule induction on the disconnected knowledge graph, comprising:
performing, for each disconnected knowledge graph, an agglomerative search constrained to edges connected from a node of interest;
performing candidate formula generation, each candidate formula representing a respective edge found by the beam search engine, each formula constrained by a requirement of at least two arguments for a formula chain length L;
performing formula evaluation to establish whether each candidate formula is valid and to select top k ranked formulas from the candidate formulas according to defined criteria;
wherein the logic formula induction repeats iterations of the agglomerative search, candidate formula generation, and formula evaluation by extending the candidate formulas to chain length L+1 for each iteration, repeating until a defined limit for chain length is reached.

9. The method of claim 8, wherein the defined criteria include coverage, accuracy, confidence score, or a combination thereof.

10. The method of claim 8, wherein the agglomerative beam search expands the search domain one hop at each iteration.

11. The method of claim 8, wherein the formulas are dynamically grounded by labeling or enumerating each node as a specific instance from among all different possibilities of connections.

12. The method of claim 8, wherein the filtering module determines that a knowledge graph satisfies a connectedness criteria and triggering a logic rule formula induction as a connected knowledge graph, the system further comprising:
a graph neural network trained to predict a first class of a query graph and to predict a second class for a distractor graph;
a counterfactual solver engine configured to solve for a minimum number of edits to the query graph toward the distractor graph which transforms the predicted first class of the query graph to the predicted second class.

13. The method of claim 12, wherein the counterfactual solver engine is further configured to:
rearrange features of the distractor graph according to a permutation matrix;
apply a first Hadamard product of the gating vector and a matrix of the rearranged features; and
apply a second Hadamard product of an inversion of the gating vector and a matrix of the query graph features;
wherein a counterfactual matrix is formed by the sum of the first and second Hadamard products, and the minimum number of edits is represented by the gating vector.

14. The method of claim 13, wherein the graph neural network is trained to learn the permutation matrix.
